(19) United States
(12) Patent Application Publication
(10) Pub. No.: US 2016/0086289 A1
(43) Pub. Date: Mar. 24, 2016

(54) DETERMINE A SCHOOL RANK UTILIZING ON-LINE SOCIAL NETWORK DATA

(71) Applicant: LinkedIn Corporation, Mountain View, CA (US)

(72) Inventors: Ada Cheuk Ying Yu, Santa Clara, CA (US); Navneet Kapur, Sunnyvale, CA (US); Vitaly Gordon, Mountain View, CA (US)

(21) Appl. No.: 14/494,425

(22) Filed: Sep. 23, 2014

(51) Int. Cl. G06Q 50/00; G06Q 50/20; G06F 17/30

(52) U.S. Cl. CPC G06Q 50/01; G06F 17/30867; G06F 17/3053; G06Q 50/20

(57) ABSTRACT

Method and system to determine a school rank utilizing on-line social network data is described. A school ranking system may be configured to determine a ranking of a school based on career outcomes data which may be Obtained from member profile data stored by an on-line social network system. The school ranking system may examine the member profiles and determine how many of the target school alumni can be considered successful alumni and then calculate a success score for a school as a number of successful alumni divided by the total number of the school's alumni.

### TECHNICAL FIELD

This application relates to the technical fields of software and/or hardware technology and, in one example embodiment, to system and method to determine a school rank utilizing on-line social network.

### BACKGROUND

Since the beginning of time people have been asking what is the best university and found some sort of responses in publications such as “US News and World Report,” “Times Higher Education,” in various academic rankings of the world, etc. While various existing rankings are out there, many are all based on data such as reputation surveys, faculty resources, admission scores, admittance rate, which often resemble self-reinforcing popularity contests. One example is a school ranking based on the admittance rate: the higher a school is in the ranking, the more students are likely to apply to that school; the more students applying to a school, the lower is the admittance rate, which in itself boosts the school's ranking.

An on-line social network may be viewed as a platform to connect people in virtual space, An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be include one or more web pages, or a structured representation of the member's information in XML (Extensible Markup Language), JSON (JavaScript Object Notation), etc. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to determine a school rank utilizing on-line social network data may be implemented;

FIG. 2 is block diagram of a system to determine a school rank utilizing on-line social network data, in accordance with one example embodiment;

FIG. 3 is a flow chart of a method to determine a school rank utilizing on-line social network data, in accordance with an example embodiment.

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to determine a school rank utilizing on-line social network data is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc). The profile of a member may also include information about the member's current and past employment, such as company identifications, professional titles held by the associated member at the respective companies, as well as the member's dates of employment at those companies.

School ranking, such as, e.g., the ranking of higher education institutions, is extremely important not only to prospective students, who are in the process of choosing a university to attend, but also to parents, alumni, educators, as well as to employers. One perceived reason that perspective students may be choosing to go to a higher ranked university is that they wish to get a good job upon graduation and to be able to earn more money. One approach to determining a rank for a higher education institution, which may also be referred merely as a school, relies on the assumption that school A should be ranked higher than school B if the graduates of school A tend to obtain jobs at more desirable or higher ranking companies than the graduates of school B.

For the purposes of this description, a computer-implemented system for determining respective ranks for schools represented by items in an electronically-stored set (a set of schools) may be referred to as a school ranking system. A school ranking system may be configured to determine a ranking of a school based on so-called career outcomes data. Career outcomes data may be obtained from member profile data stored by an on-line social network system that focuses on professional profiles of its members. Member profiles in an on-tine social network system, together with the associated data, may include information, such as a university attended by a member represented by a member profile, a type of degree obtained by the member at that university, whether the member had an internship and at which company, when and at which company the member got their first job, etc.

In order to determine a score for a particular school—referred to as a target school—a school ranking system may examine member profiles representing respective members of the on-line social network system to determine how many of the target school alumni can be considered successful alumni. Successful alumni, for the purposes of this description, are those that obtained employment at one of the top-ranked companies. In one embodiment, a school ranking system may access or extract education data and employment data from member profiles maintained by an on-line social network system. Education data, that may be found in the education section of a member profile, may then be used to determine a set of profiles—termed an alumni set of profiles—that include data that indicate that the respective members represented by the profiles in the alumni set of profiles are alumni of the target school. Employment data, that may be found in the experience section of a member profile, may then be used to determine another set of profiles—termed a successful alumni set of profiles—that include data that indicate that the respective members represented by the profiles in the successful alumni set of profiles are those alumni of the target school that that obtained employment at one of the top-ranked companies. In one embodiment, the profiles selected by the school ranking system to be included in the successful alumni set of profiles are those profiles that indicate that an alumnus represented by the member profile obtained employment at one of the top-ranked companies within a certain number of years post-graduation. In another embodiment, successful alumni may be identified as those that obtained a position at or higher than a certain seniority level and/or at one of the companies in the set of top-ranking companies. The top-ranked companies may be represented by respective items in an electronically-stored list of companies.

A ranking or a success score for a school may be calculated as a number of successful alumni (e.g., based on the company they are employed at and, in some cases, their job seniority) divided by the total number of the school's alumni. The number of successful alumni of a target school may be determined by determining the number of profiles in the successful alumni set of profiles, The number of total alumni of a target school may be determined by determining the number of profiles in the alumni set of profiles or by obtaining this information from other sources, such as, e.g., from a third-party database,

A score for a school may be calculated as an overall success score or as a success score for a particular field of study or for a particular industry, such as, e.g., computer science, finance, architecture, etc. When a score for a school is being calculated for a particular field of study or for a particular industry, the school ranking system may utilize a list of companies associated with that particular field of study or industry.

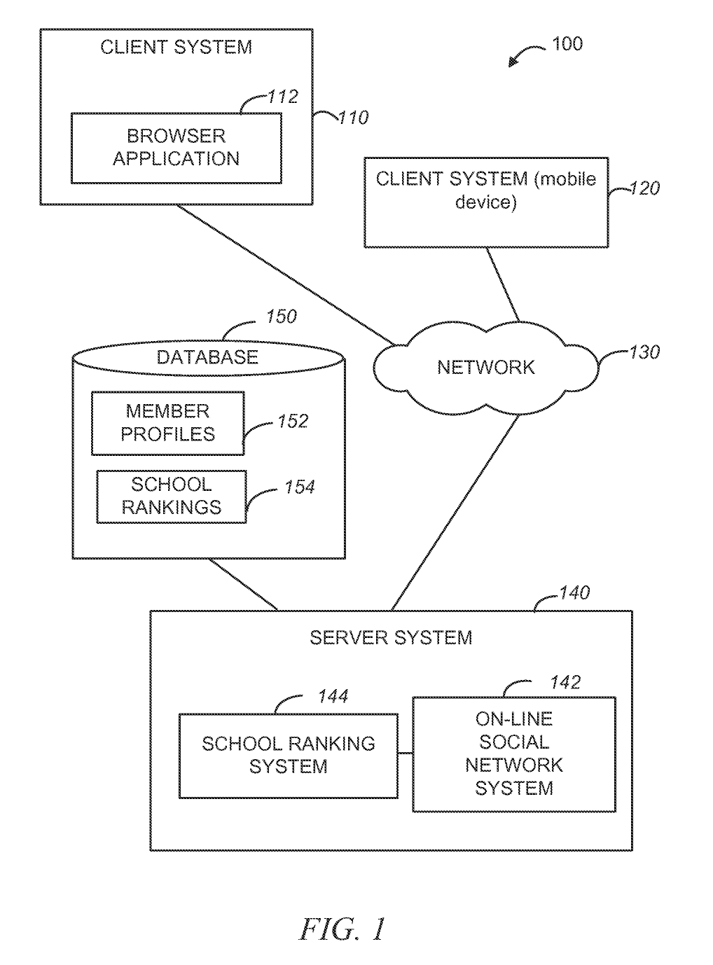

A score for a school may be stored in a database for future use. In one embodiment, the school ranking system may generate a presentation screen that includes an identification of a school together with an associated success score. A school ranking system may be configured to cause the presentation screen to be rendered on a display device of a user. Example method and system to determine a school rank utilizing on-line social network data may be implemented in the context of a network environment 100 illustrated in FIG. 1.

As shown in FIG. 1, the network environment 100 may include client systems 110 and 120 and a server system 140, The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a school ranking system 144 that may be utilized beneficially to determine respective success scores for higher education institutions referred to as schools for the sake of brevity. The school ranking system 144 may be configured to determine a ranking of a school based on career outcomes data, which may be obtained from member profile data stored by the on-line social network system 142. The school ranking system 144 may examine the member profiles and determine how many of the target school alumni can be considered successful alumni. The school ranking system 144 may then calculate a success score for a school as a number of successful alumni divided by the total number of the school's alumni.

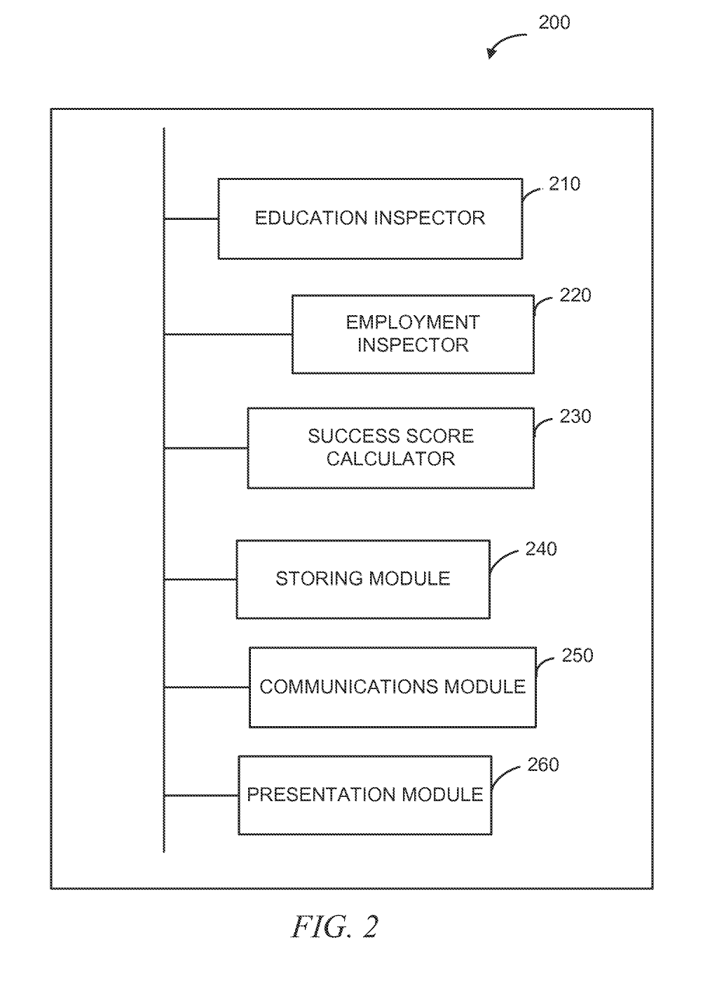

As mentioned above, a success score for a school may be calculated as an overall success score or as a success score for a particular field of study or for a particular industry. For example, the score for Stanford University in the field of computer science may be calculated as the number of successful alumni (the number of people who attended Stanford University, received a degree in computer science from Stanford University, and obtained a job at one of the 50 most highly-ranked companies, divided by the total number of people who attended Stanford University, received a degree in computer science from Stanford University. When a score for a school is being calculated for a particular field of study or for a particular industry, the school ranking system may utilize a list of companies associated with that particular field of study or industry. Respective success scores calculated by the school ranking system 144 for various schools may be stored in the database 150, as school rankings 154. An example school ranking system 144 is illustrated in FIG. 2.

FIG. 2 is a block diagram of a system 200 to determine a school rank utilizing on-line social network data, in accordance with one example embodiment. As shown in FIG. 2, the system 200 includes an education inspector 210, an employment inspector 220, a success score calculator 230, and a storing module 240. The education inspector 210 may be configured to select, from a plurality of member profiles, a set of alumni profiles. Each profile from the set of alumni profiles includes data indicating that a member represented by a respective profile from the set of alumni profiles graduated from a particular school. The school that is the subject of determining a success score by a school ranking system may be referred to as a target school. A target school may be identified by a target school identifier. As explained above, a member profile from the plurality of member profiles representing a member of an on-line social network system.

The employment inspector 220 may be configured to examine profiles in the set of alumni profiles in order to select profiles for inclusion in a set of successful alumni profiles. Each profile from the set of successful alumni profiles includes data indicating that a member represented by a respective profile from the set of successful alumni profiles obtained employment at a company represented by an item from a list of companies. The items in the list of companies represent companies that have been determined as particularly successful and thus desirable from the perspective of potential employees. This list may be referred to as a list of top-ranking companies. Company rankings or scores may be stored in a database as associated with respective company identifiers and may be determined utilizing a variety of computer-implemented methods.

The success score calculator 230 may be configured to calculate a success score for a target school as a number of items in the set of successful alumni profiles divided by a number of items in the set of alumni profiles. The success score calculator 230 may be configured to periodically recalculate success scores for target schools. As explained above, the calculated success score for a target school may indicate overall success or success with respect to a particular field of study. When the success score for a target school is calculated with respect to a particular field of study, the education inspector 210 considers only those member profiles that indicate that the member represented by a respective profile graduated from the target school with a degree in that particular field of study. Also, the list of companies utilized by the employment inspector 220 may be selected based that particular field of study or the subject discipline. The storing module 240 may be configured to store, in a database, the success score as associated with the target school identifier.

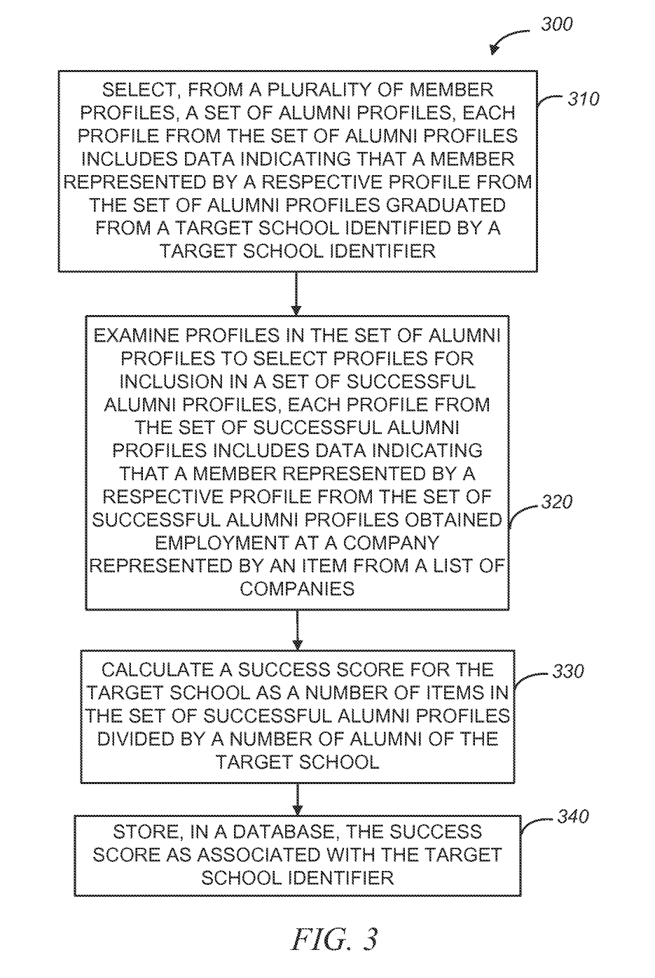

The system may also include a communications module 250 and a presentation module 260. As mentioned above, the number of alumni of the target school may be determined as the number of items in the set of alumni profiles. Alternatively, the number of alumni of the target school may be determined from one or more other sources. For example, the communications module 250 may be configured to obtain data from a third-party database to determine the number of alumni of the target school. The presentation module 260 may be configured to cause the success score for the target school to be presented on a display device of a user. For example, the presentation module 260 may generate a presentation screen that includes the success score for the target school. Some operations performed by the system 200 may be described with reference to FIG. 3.

FIG. 3 is a flow chart of a method 300 to determine a school rank utilizing on-line social network data to a social network member, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the education inspector 210 of FIG. 2 selects, from a plurality of member profiles, a set of alumni profiles. The selection is performed such that each profile in the set of alumni profiles includes data indicating that a member represented by a respective profile from the set of alumni profiles graduated from a particular school. At operation 320, the employment inspector 220 of FIG. 2 examines profiles in the set of alumni profiles in order to select profiles for inclusion in a set of successful alumni profiles. The profiles for inclusion in a set of successful alumni profiles are selected such that each profile in the set of successful alumni profiles includes data indicating that a member represented by a respective profile from the set of successful alumni profiles obtained employment at a company represented by an item from a list of companies. In some embodiments, profiles selected for inclusion in the successful alumni profiles set may be those that indicate that respective members represented by those profiles obtained a position at or higher than a certain seniority level and/or at one of the companies in the set of top-ranking companies.

At operation 330, the success score calculator 230 of FIG. 2 calculates a success score for a target school as a number of items in the set of successful alumni profiles divided by a number of items in the set of alumni profiles. The storing module 240 of FIG. 2 stores the success score calculated by the success score calculator 230 as associated with the target school identifier at operation 340.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

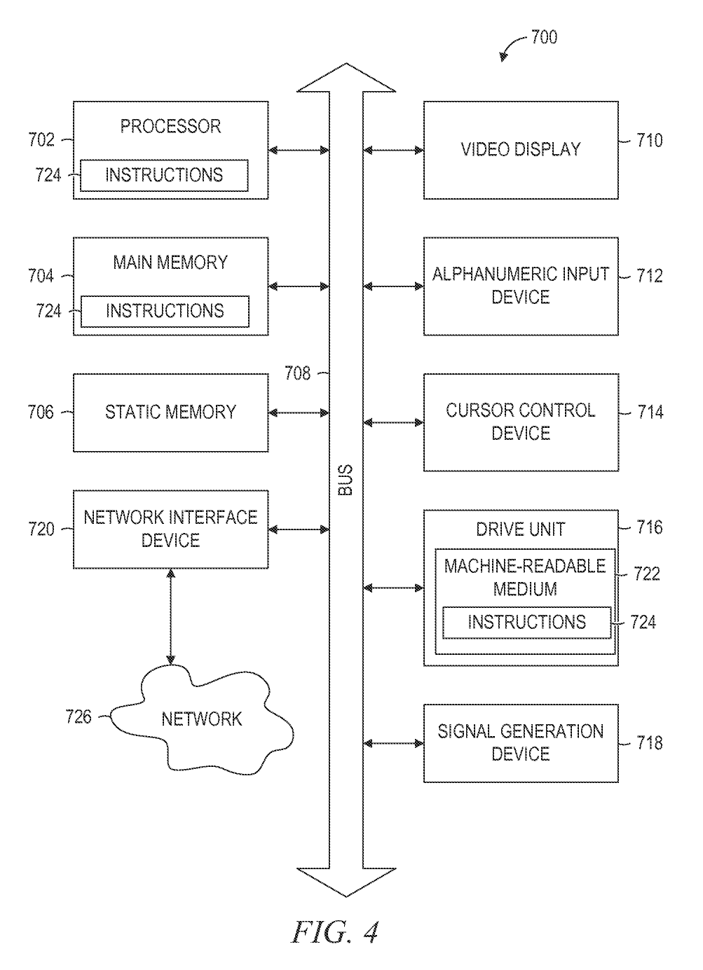

FIG. 4 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed,

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules, A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations, It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to determine a school rank utilizing on-line social network data have been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
from a plurality of member profiles, selecting a set of alumni profiles, each profile from the set of alumni profiles includes data indicating that a member represented by a respective profile from the set of alumni profiles graduated from a target school identified by a target school identifier, a member profile from the plurality of member profiles representing a member of an on-line social network system;
examining profiles in the set of alumni profiles to select profiles for inclusion in a set of successful alumni profiles, each profile from the set of successful alumni profiles includes data indicating that a member represented by a respective profile from the set of successful alumni profiles obtained employment at a company represented by an item from a list of companies;
calculating, using at least one processor, a success score for the target school as a number of items in the set of successful alumni profiles divided by a number of alumni of the target school; and
storing, in a database, the success score as associated with the target school identifier.
from a plurality of member profiles, selecting a set of alumni profiles, each profile from the set of alumni profiles includes data indicating that a member represented by a respective profile from the set of alumni profiles graduated from a target school identified by a target school identifier, a member profile from the plurality of member profiles representing a member of an on-line social network system;
examining profiles in the set of alumni profiles to select profiles for inclusion in a set of successful alumni profiles, each profile from the set of successful alumni profiles includes data indicating that a member represented by a respective profile from the set of successful alumni profiles obtained employment at a company represented by an item from a list of companies;
calculating, using at least one processor, a success score for the target school as a number of items in the set of successful alumni profiles divided by a number of alumni of the target school; and
storing, in a database, the success score as associated with the target school identifier.

2. The method of claim 1, wherein the selecting from the set of alumni profiles comprises examining education section of a profile from the set of profiles.

3. The method of claim 1, wherein:
each profile from the set of alumni profiles includes data indicating that a member represented by a respective profile from the set of alumni profiles graduated from a target school identified by a target school identifier in a subject discipline;
the number of alumni of the target school is a number of alumni of the target school based on the subject discipline; and
the list of companies is selected based on the subject discipline.

4. The method of claim 1, the number of alumni of the target school is the number of items in the set of alumni profiles.

5. The method of claim 1, comprising obtaining data from a third-party database to determine the number of alumni of the target school.

6. The method of claim 1, comprising causing the success score for the target school to be presented on a display device of a user.

7. The method of claim 6, comprising generating a presentation screen including the success score for the target school.

8. The method of claim 1, comprising recalculating, periodically the success score for the target school.

9. The method of claim 1, comprising:
selecting a set of school identifiers, each school identifier representing a higher educational institution, the set of school identifiers including the target school identifier; and
for each item in the set of school identifiers, calculating a respective success score.

10. The method of claim 1, wherein the on-line social network system is a business-oriented social networking service.

11. A computer-implemented system comprising:
an education inspector, implemented using at least one processor, to select from a plurality of member profiles, a set of alumni profiles, each profile from the set of alumni profiles includes data indicating that a member represented by a respective profile from the set of alumni profiles graduated from a target school identified by a target school identifier, a member profile from the plurality of member profiles representing a member of an on-line social network system;
an employment inspector, implemented using at least one processor, to examine profiles in the set of alumni profiles to select profiles for inclusion in a set of successful alumni profiles, each profile from the set of successful alumni profiles includes data indicating that a member represented by a respective profile from the set of successful alumni profiles obtained employment at a company represented by an item from a list of companies;
a success score calculator, implemented using at least one processor, to calculate a success score for the target school as a number of items in the set of successful alumni profiles divided by a number of alumni of the target school; and
a storing module, implemented using at least one processor, to store in a database, the success score as associated with the target school identifier.

12. The system of claim 11, wherein the education inspector is to examine education section of a profile from the set of profiles.

13. The system of claim 11, wherein:
each profile from the set of alumni profiles includes data indicating that a member represented by a respective profile from the set of alumni profiles graduated from a target school identified by a target school identifier in a subject discipline;
the number of alumni of the target school is a number of alumni of the target school based on the subject discipline; and
the list of companies is selected based on the subject discipline.

14. The system of claim 11, the number of alumni of the target school is the number of items in the set of alumni profiles.

15. The system of claim 11, comprising a communications module, implemented using at least one processor, to obtain data from a third-party database to determine the number of alumni of the target school.

16. The system of claim 11, comprising a presentation module, implemented using at least one processor, to cause the success score for the target school to be presented on a display device of a user.

17. The system of claim 16, wherein the presentation module is to generate a presentation screen including the success score for the target school.

18. The system of claim 11, wherein the success score calculator is to recalculate, periodically the success score for the target school.

19. The system of claim 11, comprising:
selecting a set of school identifiers, each school identifier representing a higher educational institution, the set of school identifiers including the target school identifier; and
for each item in the set of school identifiers, calculating a respective success score.

20. A machine-readable non-transitory storage medium having instruction data executable by a machine to cause the machine to perform operations comprising:
from a plurality of member profiles, selecting a set of alumni profiles, each profile from the set of alumni profiles includes data indicating that a member represented by a respective profile from the set of alumni profiles graduated from a target school identified by a target school identifier, a member profile from the plurality of member profiles representing a member of an on-line social network system;
examining profiles in the set of alumni profiles to select profiles for inclusion in a set of successful alumni profiles, each profile from the set of successful alumni profiles includes data indicating that a member represented by a respective profile from the set of successful alumni profiles obtained employment at a company represented by an item from a list of companies;
calculating a success score for the target school as a number of items in the set of successful alumni profiles divided by a number of alumni of the target school; and
storing, in a database, the success score as associated with the target school identifier.
